(19) United States
(12) Patent Application Publication
(10) Pub. No.: US 2026/0322272 A1
(43) Pub. Date: Oct. 15, 2026

(54) Isolated Inter-Pole Voltage Self-Balancing Circuit Based on an L-Type Current-Input Configuration

(71) Applicant: CHINA THREE GORGES UNIVERSITY, Yichang (CN)

(72) Inventors: Xiaoli SHE, Yichang (CN); Zhenyu ZHENG, Yichang (CN); Binxin ZHU, Yichang (CN); Shengqi ZHOU, Yichang (CN); Hailong PAN, Yichang (CN); Chuang LIU, Yichang (CN)

(21) Appl. No.: 19/465,315

(22) Filed: Jan. 30, 2026

(30) Foreign Application Priority Data
Dec. 2, 2024 (CN) 202411753213.1

(51) Int. Cl. H02M 3/28; H02M 1/00; H02M 3/335

(52) U.S. Cl. CPC H02M 3/285; H02M 1/0043; H02M 3/33571

(57) ABSTRACT

An isolated inter-pole voltage self-balancing circuit based on an L-type current-input configuration is provided. The circuit includes one input voltage source uin, two field-effect transistors S₁ and S₂, two inductors L₁ and L₂, one transformer T, four switching diodes D₁₁, D₁₂, D₂₁, and D₂₂, four capacitors C₁, C₂, Cp, and CN, and bipolar loads Rp and RN. The circuit employs an L-type current-input topology with interleaved control, such that currents flowing through the input inductors L₁ and L₂ are interleaved and complementary, thereby effectively reducing input current ripple. A bipolar voltage-doubling unit is utilized to compensate for inter-pole voltage deviation caused by unbalanced loads, thereby achieving automatic inter-pole voltage self-balancing. The circuit does not rely on detection of voltage imbalance and does not require complex sampling or control algorithms, thus reducing design complexity.

### CROSS-REFERENCE TO RELATED APPLICATIONS

This application claims foreign priority of Chinese Patent Application No. 202411753213.1, filed on 2 Dec. 2024 in the China National Intellectual Property Administration (CNIPA), the entire contents of which are hereby incorporated by reference in their entireties.

### TECHNICAL FIELD

The present invention relates to a bipolar output circuit, and more particularly to an isolated inter-pole voltage self-balancing circuit based on an L-type current-input configuration.

### BACKGROUND OF THE INVENTION

The widespread adoption of renewable energy sources such as photovoltaic cells and fuel cells, as well as emerging loads such as electric vehicles, has promoted the development and application of DC microgrid systems. As unipolar DC microgrids are increasingly unable to meet the efficiency and reliability requirements of many emerging applications, bipolar DC microgrids are commonly adopted as a solution for interfacing various renewable energy sources and emerging loads. Due to their higher reliability, flexibility, and efficiency, bipolar DC microgrids have attracted increasing attention. However, the presence of unbalanced loads may cause neutral-point voltage deviation, which is detrimental to the stable operation of bipolar DC microgrids. In addition, the output voltage generated by renewable energy systems is generally low and unstable, and therefore high step-up DC converters are typically required to increase the output voltage level. Meanwhile, circuit topologies with low input current ripple can improve the service life and operational efficiency of photovoltaic cells and fuel cells. Accordingly, the development of a high-gain converter featuring low input current ripple and inter-pole voltage self-balancing capability has significant engineering application value. Patent application publication No. CN116317626A discloses a novel voltage balancer with continuous input and output currents and a corresponding control strategy. Although the disclosed converter can address inter-pole voltage imbalance, it does not provide electrical isolation and requires detection of the inter-pole voltage to regulate the conduction scheme of switching devices, resulting in a complex control strategy.

### SUMMARY OF THE INVENTION

To address the inter-pole voltage deviation caused by bipolar load imbalance, the present invention proposes an isolated inter-pole voltage self-balancing circuit based on an L-type current-input configuration. The voltage self-balancing circuit employs an L-type current-input topology with interleaved control, such that currents flowing through input inductors L₁ and L₂ are interleaved and complementary, thereby effectively reducing input current ripple. A bipolar voltage-doubling unit is utilized to compensate for inter-pole voltage deviation caused by load imbalance, thereby achieving automatic inter-pole voltage balancing. The circuit does not rely on detection of voltage imbalance and does not require complex sampling or control algorithms, thus reducing design complexity. The circuit is suitable for applications requiring high voltage gain, low current ripple, and bipolar power supply.

The technical solution adopted by the present invention is as follows:

An isolated inter-pole voltage self-balancing circuit based on an L-type current-input configuration, comprising an isolated front-stage circuit constructed based on an L-type current-input topology and a rear-stage bipolar voltage self-balancing circuit.

The isolated front-stage circuit constructed based on the L-type current-input topology comprises an input voltage source uin, field-effect transistors S₁ and S₂, inductors L₁ and L₂, and a transformer T, with specific connections as follows:

A positive terminal of the input voltage source uin is respectively connected to a positive terminal of inductor L₁ and a positive terminal of inductor L₂, and a negative terminal of the input voltage source uin is respectively connected to a source terminal of field-effect transistor S₁ and a source terminal of field-effect transistor S₂; a negative terminal of inductor L₁ is respectively connected to a drain terminal of field-effect transistor S₁ and a positive terminal of a primary winding L_{P} of the transformer T; and a negative terminal of inductor L₂ is respectively connected to a drain terminal of field-effect transistor S₂ and a negative terminal of the primary winding L_{P} of the transformer T.

The rear-stage bipolar voltage self-balancing circuit comprises the transformer T, switching diodes D₁₁, D₁₂, D₂₁, and D₂₂, capacitors C₁, C₂, C_{P}, and C_{N}, and loads R_{P} and R_{N}, with specific connections as follows:

A positive terminal of a secondary winding Lₛ of the transformer T is respectively connected to a negative terminal of capacitor C₁ and a positive terminal of capacitor C₂.

A negative terminal of the secondary winding Lₛ of the transformer T is respectively connected to an anode of switching diode D₁₂ and a cathode of switching diode D₂₁.

A positive terminal of capacitor C₁ is respectively connected to a cathode of switching diode D₁₂ and an anode of switching diode D₁₁.

A negative terminal of capacitor C₂ is respectively connected to a cathode of switching diode D₂₂ and an anode of switching diode D₂₁.

A positive terminal of capacitor C_{P} is respectively connected to a cathode of switching diode D₁₁ and a positive terminal of load R_{P}.

A negative terminal of capacitor C_{P} is respectively connected to a cathode of switching diode D₂₁, an anode of switching diode D₁₂, a negative terminal of load R_{P}, a positive terminal of load R_{N}, and a positive terminal of capacitor C_{N}.

A negative terminal of capacitor C_{N} is respectively connected to an anode of switching diode D₂₂ and a negative terminal of load R_{N}.

The field-effect transistors S₁ and S₂ are controlled in an interleaved manner with a phase difference of 180°, wherein a duty cycle D_{S1} of the field-effect transistor S₁ is equal to a duty cycle D_{S2} of the field-effect transistor S₂, and the duty cycles D_{S1} and D_{S2} are greater than or equal to 0.5, thereby achieving a step-up inversion effect.

The operation includes Mode 1 through Mode 3:

Mode 1: All field-effect transistors are turned on and all diodes are turned off. Inductor currents i_{L1} and i_{L2} both increase linearly. Capacitors C_{P} and C_{N} respectively supply power to their parallel-connected loads, while the voltages of the remaining capacitors remain unchanged.

$$\{ \begin{matrix}{u}_{L 1} = {u}_{in} \\ {u}_{L 2} = {u}_{in}\end{matrix} ; \qquad ( 1 )$$

Mode 2: Field-effect transistor S₁ is turned off and field-effect transistor S₂ is turned on; diodes D₁₁ and D₂₁ are forward-biased and conduct, while diodes D₁₂ and D₂₂ are reverse-biased and turned off. Inductor current i_{L1} decreases linearly, and inductor current i_{L2} increases linearly. Inductor current i_{L1} forms a loop through the primary winding L_{P} of transformer T and field-effect transistor S₂. On the secondary side of transformer T, current flows out from the positive terminal of the secondary winding Lₛ, charging capacitor C₂ through the loop Lₛ-C₂-D₂₁ and charging capacitor C_{P} through the loop Lₛ-C₁-D₁₁-C_{P}, while capacitor C_{N} supplies power to load R_{N}.

$$\{ \begin{matrix}- {u}_{L 1} = \frac{{u}_{c 2}}{k} - {u}_{in} = \frac{{u}_{CP} - {u}_{C 1}}{k} - {u}_{in} \\ {u}_{L 2} = {u}_{in}\end{matrix} ; \qquad ( 2 )$$

Mode 3: Field-effect transistor S₂ is turned off and field-effect transistor S₁ is turned on; diodes D₁₂ and D₂₂ are forward-biased and conduct, while diodes D₁₁ and D₂₁ are reverse-biased and turned off. Inductor current i_{L1} increases linearly, and inductor current i_{L2} decreases linearly. Inductor current i_{L2} forms a loop through the primary winding L_{P} of transformer T and field-effect transistor S₁. On the secondary side of transformer T, current flows out from the negative terminal of the secondary winding Lₛ, charging capacitor C₁ through the loop Lₛ-D₁₂-C₁ and charging capacitor C_{N} through the loop Lₛ-C_{N}-D₂₂-C₂, while capacitor C_{P} supplies power to load R_{P}.

$$\{ \begin{matrix}{u}_{L 1} = {u}_{in} \\ - {u}_{L 2} = \frac{{u}_{C 1}}{k} - {u}_{in} = \frac{{u}_{CN} - {u}_{C 2}}{k} - {u}_{in}\end{matrix} ; \qquad ( 3 )$$

Where k=ns:np. Based on the above mode analysis and in combination with the volt-second balance characteristic of the inductors, the voltage gain can be obtained as follows:

$$\{ \begin{matrix}{u}_{C 1} = {u}_{C 2} = \frac{{ku}_{in}}{1 - D} \\ {u}_{CP} = {u}_{CN} = \frac{2 {ku}_{in}}{1 - D} \\ M = \frac{2 k}{1 - D}\end{matrix} . \qquad ( 4 )$$

When field-effect transistor S₁ is turned off and field-effect transistor S₂ is turned on, diodes D₁₁ and D₂₁ conduct, and capacitors C₁ and C₂ are connected in series and in parallel with capacitor C_{P}. When field-effect transistor S₂ is turned off and field-effect transistor S₁ is turned on, diodes D₁₂ and D₂₂ conduct, and capacitors C₁ and C₂ are connected in series and in parallel with capacitor C_{N}. Therefore, capacitors C_{P} and C_{N} are clamped to the same voltage, thereby realizing automatic inter-pole voltage balancing. The balancing error is mainly affected by capacitor voltage ripple, which can be neglected when the capacitance values are sufficiently large.

The isolated inter-pole voltage self-balancing circuit based on an L-type current-input configuration according to the present invention achieves the following technical effects:
(1) Electrical isolation is realized by means of a high-frequency transformer, thereby improving power supply reliability and safety.
(2) Interleaved control is adopted, such that currents flowing through input inductors L₁ and L₂ are interleaved and complementary, thereby effectively reducing input current ripple.
(3) The circuit features simple control and does not rely on complex voltage monitoring or control systems for regulation; automatic balancing of bipolar outputs is achieved through a bipolar voltage-doubling unit.

### BRIEF DESCRIPTION OF DRAWINGS

The present invention will be further described below in conjunction with the accompanying drawings and embodiments:

FIG. 1 is a circuit schematic diagram of the present invention;

FIG. 2 is a simulation waveform diagram of output voltages under positive and negative load imbalance when the present invention is applied;

FIG. 3 is a simulation waveform diagram of the input current and currents flowing through inductors L₁ and L₂ when the present invention is applied.

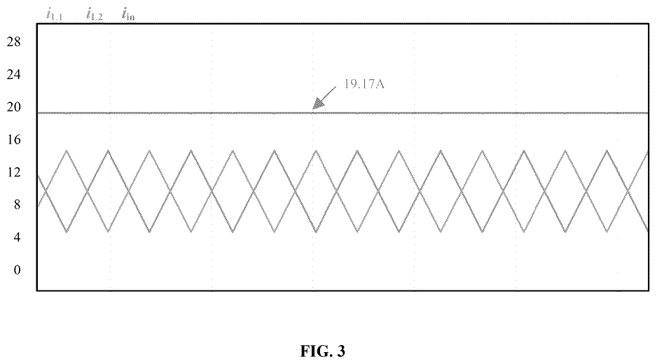

In FIGS. 2 and 3, all operating conditions are identical.

### DETAILED DESCRIPTION OF THE INVENTION

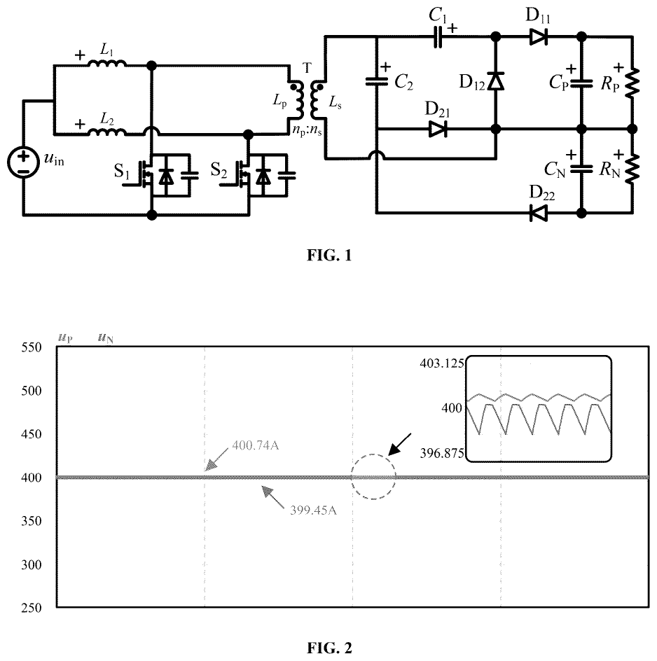

As shown in FIG. 1, an isolated inter-pole voltage self-balancing circuit based on an L-type current-input configuration is provided. The circuit comprises an isolated front-stage circuit constructed based on an L-type current-input topology and a rear-stage bipolar voltage self-balancing circuit.

The isolated front-stage circuit constructed based on the L-type current-input topology comprises an input voltage source uin, field-effect transistors S₁ and S₂, inductors L₁ and L₂, and a transformer T. The specific connections are as follows:

A positive terminal of the input voltage source uin is respectively connected to positive terminals of inductors L₁ and L₂, and a negative terminal of the input voltage source uin is respectively connected to source terminals of field-effect transistors S₁ and S₂. A negative terminal of inductor L₁ is respectively connected to a drain terminal of field-effect transistor S₁ and a positive terminal of a primary winding L_{P} of the transformer T. A negative terminal of inductor L₂ is respectively connected to a drain terminal of field-effect transistor S₂ and a negative terminal of the primary winding L_{P} of the transformer T.

The rear-stage bipolar voltage self-balancing circuit comprises the transformer T, switching diodes D₁₁, D₁₂, D₂₁, and D₂₂, capacitors C₁, C₂, CP, and C_{N}, and loads R_{P} and R_{N}. The specific connections are as follows:

A positive terminal of a secondary winding Lₛ of the transformer T is respectively connected to a negative terminal of capacitor C₁ and a positive terminal of capacitor C₂. A negative terminal of the secondary winding Lₛ is respectively connected to an anode of switching diode D₁₂ and a cathode of switching diode D₂₁. A positive terminal of capacitor C₁ is respectively connected to a cathode of switching diode D₁₂ and an anode of switching diode D₁₁. A negative terminal of capacitor C₂ is respectively connected to a cathode of switching diode D₂₂ and an anode of switching diode D₂₁. A positive terminal of capacitor C_{P} is respectively connected to a cathode of switching diode D₁₁ and a positive terminal of load R_{P}. A negative terminal of capacitor C_{P} is respectively connected to a cathode of switching diode D₂₁, an anode of switching diode D₁₂, a negative terminal of load R_{P}, a positive terminal of load R_{N}, and a positive terminal of capacitor C_{N}. A negative terminal of capacitor C_{N} is respectively connected to an anode of switching diode D₂₂ and a negative terminal of load R_{N}.

Field-effect transistors S₁ and S₂ are controlled in an interleaved manner with a phase difference of 180°, such that a duty cycle D_{S1} of field-effect transistor S₁ is equal to a duty cycle D_{S2} of field-effect transistor S₂, and the duty cycles D_{S1} and D_{S2} are greater than or equal to 0.5, thereby realizing a step-up inversion effect.

When field-effect transistor S₁ is turned off and field-effect transistor S₂ is turned on, diodes D₁₁ and D₂₁ conduct, and capacitors C₁ and C₂ are connected in series and in parallel with capacitor C_{P}. When field-effect transistor S₂ is turned off and field-effect transistor S₁ is turned on, diodes D₁₂ and D₂₂ conduct, and capacitors C₁ and C₂ are connected in series and in parallel with capacitor C_{N}. Accordingly, capacitors C_{P} and C_{N} are clamped to the same voltage, thereby achieving automatic inter-pole voltage self-balancing. The balancing error is mainly affected by capacitor voltage ripple, which can be neglected when the capacitance values are sufficiently large.

As can be seen from FIG. 2, when the present invention is applied under conditions of unbalanced dual loads (RP=500Ω and R_{N}=100Ω), the output voltages are 400.74 V and 399.45 V, respectively. Under load imbalance, output voltage self-balancing is achieved solely by the circuit itself, with a voltage deviation of only 1.29 V, thereby resolving the problem that the output voltages cannot be self-balanced.

As can be seen from FIG. 3, when the present invention is applied, the currents of input inductors L₁ and L₂ are interleaved with each other, and the input current is 19.17 A, thereby achieving an almost zero-ripple input current.

The circuit of the present invention is based on an L-type current-input topology and employs interleaved control, such that currents flowing through input inductors L₁ and L₂ are interleaved and complementary, thereby effectively reducing input current ripple. By means of a bipolar voltage-doubling unit, inter-pole voltage deviation caused by unbalanced loads is mitigated, thereby achieving automatic inter-pole voltage self-balancing. The circuit does not rely on detection of voltage imbalance and does not require complex sampling or control algorithms, thus reducing design complexity. The circuit is suitable for applications requiring high voltage gain, low current ripple, and bipolar power supply.

1. An isolated inter-pole voltage self-balancing circuit based on an L-type current-input configuration, comprising:
an isolated front-stage circuit constructed based on an L-type current-input topology, and a rear-stage bipolar voltage self-balancing circuit;
wherein the isolated front-stage circuit constructed based on the L-type current-input topology comprises an input voltage source uin, field-effect transistors S₁ and S₂, inductors L₁ and L₂, and a transformer T, with the following connections:
a positive terminal of the input voltage source uin is respectively connected to a positive terminal of inductor L₁ and a positive terminal of inductor L₂, and a negative terminal of the input voltage source uin is respectively connected to a source terminal of field-effect transistor S₁ and a source terminal of field-effect transistor S₂;
a negative terminal of inductor L₁ is respectively connected to a drain terminal of field-effect transistor S₁ and a positive terminal of a primary winding L_{P} of the transformer T;
a negative terminal of inductor L₂ is respectively connected to a drain terminal of field-effect transistor S₂ and a negative terminal of the primary winding L_{P} of the transformer T;
wherein the rear-stage bipolar voltage self-balancing circuit comprises the transformer T, switching diodes D₁₁, D₁₂, D₂₁, and D₂₂, capacitors C₁, C₂, C_{P}, and C_{N}, and loads R_{P} and R_{N}, with the following connections:
a positive terminal of a secondary winding Lₛ of the transformer T is respectively connected to a negative terminal of capacitor C₁ and a positive terminal of capacitor C₂;
a negative terminal of the secondary winding Lₛ of the transformer T is respectively connected to an anode of switching diode D₁₂ and a cathode of switching diode D₂₁;
a positive terminal of capacitor C₁ is respectively connected to a cathode of switching diode D₁₂ and an anode of switching diode D₁₁;
a negative terminal of capacitor C₂ is respectively connected to a cathode of switching diode D₂₂ and an anode of switching diode D₂₁;
a positive terminal of capacitor C_{P} is respectively connected to a cathode of switching diode D₁₁ and a positive terminal of load R_{P};
a negative terminal of capacitor C_{P} is respectively connected to a cathode of switching diode D₂₁, an anode of switching diode D₁₂, a negative terminal of load R_{P}, a positive terminal of load R_{N}, and a positive terminal of capacitor C_{N}; and
a negative terminal of capacitor C_{N} is respectively connected to an anode of switching diode D₂₂ and a negative terminal of load R_{N}.

2. The isolated inter-pole voltage self-balancing circuit according to claim 1, wherein the field-effect transistors S₁ and S₂ are controlled in an interleaved manner with a phase difference of 180°, a duty cycle D_{S1} of field-effect transistor S₁ being equal to a duty cycle D_{S2} of field-effect transistor S₂, and the duty cycles D_{S1} and D_{S2} being greater than or equal to 0.5, thereby realizing a step-up inversion effect.

3. The isolated inter-pole voltage self-balancing circuit according to claim 1, wherein the circuit operates in Mode 1 through Mode 3, comprising:
Mode 1, in which all field-effect transistors are turned on and all diodes are turned off, inductor currents i_{L1} and i_{L2} increase linearly, capacitors C_{P} and C_{N} respectively supply power to loads connected in parallel therewith, and voltages of remaining capacitors remain unchanged;
$$\{ \begin{matrix}{u}_{L 1} = {u}_{in} \\ {u}_{L 2} = {u}_{in}\end{matrix} ; \qquad ( 1 )$$
Mode 2, in which field-effect transistor S₁ is turned off and field-effect transistor S₂ is turned on, diodes D₁₁ and D₂₁ conduct while diodes D₁₂ and D₂₂ are reverse-biased and turned off, inductor current i_{L1} decreases linearly and inductor current i_{L2} increases linearly, inductor current i_{L1} forms a loop through the primary winding L_{P} of transformer T and field-effect transistor S₂, a secondary-side current of transformer T flows out from a positive terminal of the secondary winding Lₛ to charge capacitor C₂ through a loop Lₛ-C₂-D₂₁ and to charge capacitor C_{P} through a loop Lₛ-C₁-D₁₁-C_{P}, and capacitor C_{N} supplies power to load R_{N};
$$\{ \begin{matrix}- {u}_{L 1} = \frac{{u}_{c 2}}{k} - {u}_{in} = \frac{{u}_{CP} - {u}_{C 1}}{k} - {u}_{in} \\ {u}_{L 2} = {u}_{in}\end{matrix} ; \qquad ( 2 )$$
Mode 3, in which field-effect transistor S₂ is turned off and field-effect transistor S₁ is turned on, diodes D₁₂ and D₂₂ conduct while diodes D₁₁ and D₂₁ are reverse-biased and turned off, inductor current i_{L1} increases linearly and inductor current i_{L2} decreases linearly, inductor current i_{L2} forms a loop through the primary winding L_{P} of transformer T and field-effect transistor S₁, a secondary-side current of transformer T flows out from a negative terminal of the secondary winding Lₛ to charge capacitor C₁ through a loop Lₛ-D₁₂-C₁ and to charge capacitor C_{N} through a loop Lₛ-C_{N}-D₂₂-C₂, and capacitor C_{P} supplies power to load R_{P};
$$\{ \begin{matrix}{u}_{L 1} = {u}_{in} \\ - {u}_{L 2} = \frac{{u}_{C 1}}{k} - {u}_{in} = \frac{{u}_{CN} - {u}_{C 2}}{k} - {u}_{in}\end{matrix} ; \qquad ( 3 )$$
wherein k=ns:np, and a voltage gain is obtained based on the above mode analysis in combination with an inductor volt-second balance characteristic:
$$\{ \begin{matrix}{u}_{C 1} = {u}_{C 2} = \frac{{ku}_{in}}{1 - D} \\ {u}_{CP} = {u}_{CN} = \frac{2 {ku}_{in}}{1 - D} \\ M = \frac{2 k}{1 - D}\end{matrix} . \qquad ( 4 )$$

4. The isolated inter-pole voltage self-balancing circuit according to claim 1, wherein when field-effect transistor S₁ is turned off and field-effect transistor S₂ is turned on, diodes D₁₁ and D₂₁ conduct and capacitors C₁ and C₂ are connected in series and in parallel with capacitor C_{P}; and when field-effect transistor S₂ is turned off and field-effect transistor S₁ is turned on, diodes D₁₂ and D₂₂ conduct and capacitors C₁ and C₂ are connected in series and in parallel with capacitor C_{N}; such that capacitors C_{P} and C_{N} are clamped at the same voltage, thereby realizing automatic inter-pole voltage self-balancing.
